(19) United States
(12) Patent Application Publication
(10) Pub. No.: US 2024/0380670 A1
(43) Pub. Date: Nov. 14, 2024

(54) IDENTIFICATION OF NETWORK ANOMALIES

(71) Applicant: VMware, Inc., Palo Alto, CA (US)

(72) Inventors: Giri Prashanth Subramanian, Cupertino, CA (US); Wenxuan Zhou, Santa Clara, CA (US); Satyandra Guthula, Thane (IN); Santhosh Prabhu Muraleedhara Prabhu, Urbana, IL (US); Philip Brighten Godfrey, Champaign, IL (US)

(21) Appl. No.: 18/195,551

(22) Filed: May 10, 2023

(51) Int. Cl. H04L 41/14

(52) U.S. Cl. CPC H04L 41/145

(57) ABSTRACT

Some embodiments provide a method for identifying anomalies in a network. The method uses a model of the network to determine connectivity for each of multiple network endpoints to other network endpoints. The method quantifies differences in the determined connectivity for pairs of the network endpoints. The method uses the quantified differences to identify (i) clusters of network endpoints with similar properties and connectivity and (ii) anomalous network endpoints that do not fit the clusters. The anomalous endpoints are reported as potential network anomalies.

### BACKGROUND

Unexploited vulnerabilities in datacenters can be major threats to the security of an organization's infrastructure. Resources that are exposed on the network may present an opportunity for attackers to compromise critical information and possibly even bring down the entire network. In the opposite direction, errors in network configurations that overly restrict connectivity can cause unintended outages or other problems. For example, if a certain application needs its web server machines to talk to its database machines, but a firewall rule blocks this communication, then the application will not behave as intended.

To detect such vulnerabilities or broken connectivity, network administrators most commonly rely on traffic monitoring and analysis of ongoing network data flows. For example, at the simplest level, engineers use manual traceroutes or reports of ongoing application-level problems. More advanced analysis studies recent traffic patterns to recommend firewall rules or performs anomaly detection on traffic contents and communication patterns. In general, while useful, analyzing ongoing or historical traffic is limited because it only reacts to problems once they manifest. For example, an overly restrictive firewall rule may be constructed due to human error or due to analysis of historical traffic that didn't take into account future changes, but the presence of such a problem would only be noticed after the firewall rule causes an outage in a new application deployment or a relocated VM. As another example, anomaly detection will generally only catch a security vulnerability after that vulnerability is already being exploited. As such, techniques for proactively identifying these network anomalies (e.g., misconfigurations) are needed.

### BRIEF SUMMARY

Some embodiments provide a method for preemptively detecting anomalies in a network (e.g., within a datacenter) based on connectivity analysis for the network endpoints (e.g., virtual machines, containers, etc.). In some embodiments, the method uses a network model (e.g., that incorporates all of the rules implemented in the network) to determine, for each network endpoint, the connectivity to other network endpoints (e.g., to each of the other network endpoints). The method quantifies differences in this connectivity for pairs of the network endpoints and then uses these quantified differences to identify (i) clusters of network endpoints with similar properties and connectivity and (ii) anomalous network endpoints that do not fit the clusters. Some embodiments report these anomalous endpoints as potential network anomalies.

In some embodiments, the method is performed by an application (e.g., a network verification application) that stores and uses a model of the network that includes data message processing rules for each network device in the network (e.g., each physical and logical network device). These include forwarding rules, security rules, (e.g., firewall rules), etc., that define how data messages sent to and from network endpoints are processed in the network. As such, the application can simulate the processing of any theoretical data message that could occur in the network.

To perform the anomaly detection, the application first determines, for each network endpoint (of at least a subset of the network endpoints), the connectivity to each other network endpoint. In some embodiments, for each particular network endpoint, the application determines a respective set of data messages that would reach each respective other network endpoint when sent from the particular network endpoint. Specifically, for each network endpoint, some embodiments perform a free traversal of the network model using a data message set that represents a union of all possible destination addresses. The result of this traversal is a matrix that specifies the set of data messages that will reach each network endpoint when sent from each other network endpoint. It should be noted that while this network connectivity will often be symmetrical (i.e., any type of data message that reaches VM2 when sent from VM1 will also reach VM1 when sent from VM2), this may not always be the case (due to either anomalies or intentionally asymmetric rules that allow, e.g., connections to be initiated in one direction but not the other).

Next, the application uses this connectivity matrix to quantify the difference in connectivity between pairs of network endpoints. This difference is not a measure of how reachable or connected one network endpoint is from another network endpoint (that is measured by the connectivity matrix), but rather how different the overall network connectivity is for one network endpoint compared to another network endpoint. That is, if the connectivity of a first network endpoint to each other network endpoint is the same as the connectivity of a second network endpoint to each other network endpoint (with the same connectivity to each other), then there is no connectivity difference between the two network endpoints.

To quantify this difference, some embodiments first determine a group of atomic data message sets that can be combined together to generate any of the respective data message sets that are reachable at any of the network endpoints from any other network endpoint. That is, the atomic data message sets should be defined so that each entry in the connectivity matrix is a combination of one or more of the atomic data message sets (for simplicity, using as few atomic data message sets as possible). For instance, the atomic data message sets could be determined by layer 4 protocol (e.g., TCP data messages, UDP data messages, data messages other than TCP or UDP are possible data message sets), different VLANs, or other protocol headers. Each respective data message set that is reachable at one network endpoint from another network endpoint is then represented as a vector of Boolean values that defines a combination of the atomic data message sets. For instance, in the example of TCP, UDP, and non-TCP/UDP data messages, each data message set is represented as a vector of three Boolean values. If only TCP data messages reach the destination network endpoint, this is represented as (1, 0, 0). If all data messages reach the destination network endpoint, this is represented as (1, 1, 1). If all except UDP data messages reach the destination network endpoint, this is represented as (1, 0, 1), and so on.

The application then calculates, for each pair of network endpoints, a difference between their respective connectivity vectors. Thus, two network endpoints that have the same connectivity to each other network endpoint (and to each other) will have a difference of zero. This calculation, in some embodiments, entails computing a root mean square value between the vectors for each pair of network endpoints. That is, the larger the number of values that are different between the two vectors for a pair of network endpoints (indicating types of data messages that will reach a particular destination when sent from one of the network endpoints in the pair but not the other), the larger the quantified difference between the pair of network endpoints will be.

Finally, the application uses these quantified differences to identify clusters of network endpoints and anomalous network endpoints that do not fit the clusters (the latter being indicative of possible anomalies in the network configuration). To perform the clustering, some embodiments reduce the number of properties based on which to cluster the network endpoints, rather than using distance to every other network endpoint as a separate property (this approach would not scale well to large networks where each network endpoint would have thousands, if not millions, of individual properties).

Some embodiments define a set of categories with which to categorize the network endpoints and then use these categories to perform the clustering. In some embodiments, these categories are chosen based on an expectation as to which network endpoints should have similar connectivity. Thus, for example, categories such as the logical switch to which a network endpoint connects, the application and/or application tier to which a network endpoint belongs, etc., may be chosen as properties. For each category, the application computes, for each network endpoint, (i) the average quantified difference between the network endpoint and each other network endpoint having the same value for the category and (ii) the average quantified difference between the network endpoint and each other network endpoint having a different value for the category (e.g., an intra-category average and an extra-category average). That is, for each category, three properties are generated: the category itself as well as two numerical properties. Some embodiments then perform clustering based on these properties.

To use the properties for clustering, some embodiments require a definition of distance between categorical values (e.g., between a value of “logical switch 1” and “logical switch 2”) as well as a normalization of the categorical values to the numerical values. For the first, some embodiments define the distance between two categorical values to be either 1 (if the values are different) or 0 (if the values are the same). Some embodiments perform a Min Max scaling of each of the numerical properties so that the values are all between 0 and 1, then compute the distances between the normalized values (e.g., using cosine similarity). The categorical distances are also scaled (relative to the numerical distances) using a tunable weight parameter in some embodiments.

The application of some embodiments then inputs the points representing network endpoints into a clustering algorithm (e.g., a density-based clustering algorithm such as DBSCAN or OPTICS), with distances between the network endpoints defined as noted above. The output of such a clustering algorithm is a set of clusters (i.e., network endpoints having the same or extremely similar connectivity) as well as a set of anomalies that do not fit into the clusters. Because misconfiguration may result in a very small change in overall connectivity, some embodiments run a second pass to identify any network endpoints that have distances varying at all from the other members of their cluster and classify these network endpoints as potential anomalies as well.

In addition to the computational analysis, some embodiments output a reachability (connectivity) visualization, which can allow a user (e.g., a network administrator) to quickly identify potential anomalies. In some embodiments, the reachability visualization is displayed as a matrix with each row representing a network endpoint (or group of endpoints) and each column similarly representing a network endpoint or group. Each cell in the matrix indicates whether the destination endpoint (i.e., the column endpoint) is reachable from the source endpoint (i.e., the row endpoint). In some embodiments, each of the cells is colored in such a way as to represent the set of data messages that are reachable at the destination endpoint from the source endpoint.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and the Drawings is needed. Moreover, the claimed subject matters are not to be limited by the illustrative details in the Summary, Detailed Description, and the Drawings, but rather are to be defined by the appended claims, because the claimed subject matters can be embodied in other specific forms without departing from the spirit of the subject matters.

### BRIEF DESCRIPTION OF THE DRAWINGS

The novel features of the invention are set forth in the appended claims. However, for purpose of explanation, several embodiments of the invention are set forth in the following figures.

FIG. 1 conceptually illustrates the architecture of a network verification application of some embodiments.

FIG. 2 conceptually illustrates a process of some embodiments for identifying potential anomalies in a network based on connectivity analysis.

FIG. 3 conceptually illustrates an example connectivity matrix for a set of five network endpoints.

FIG. 4 conceptually illustrates a vectorized connectivity matrix 400 based on the connectivity matrix of FIG. 3.

FIG. 5 conceptually illustrates a connectivity difference matrix generated based on the vectorized connectivity matrix shown in FIG. 4,

FIG. 6 conceptually illustrates a table with property values computed for two categories based on the connectivity difference matrix of FIG. 5.

FIG. 7 illustrates an example connectivity visualization based on the connectivity matrix of FIG. 3.

FIG. 8 conceptually illustrates an electronic system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments provide a method for preemptively detecting anomalies in a network (e.g., within a datacenter) based on connectivity analysis for the network endpoints (e.g., virtual machines, containers, etc.). In some embodiments, the method uses a network model (e.g., that incorporates all of the rules implemented in the network) to determine, for each network endpoint, the connectivity to other network endpoints (e.g., to each of the other network endpoints). The method quantifies differences in this connectivity for pairs of the network endpoints and then uses these quantified differences to identify (i) clusters of network endpoints with similar properties and connectivity and (ii) anomalous network endpoints that do not fit the clusters. Some embodiments report these anomalous endpoints as potential network anomalies.

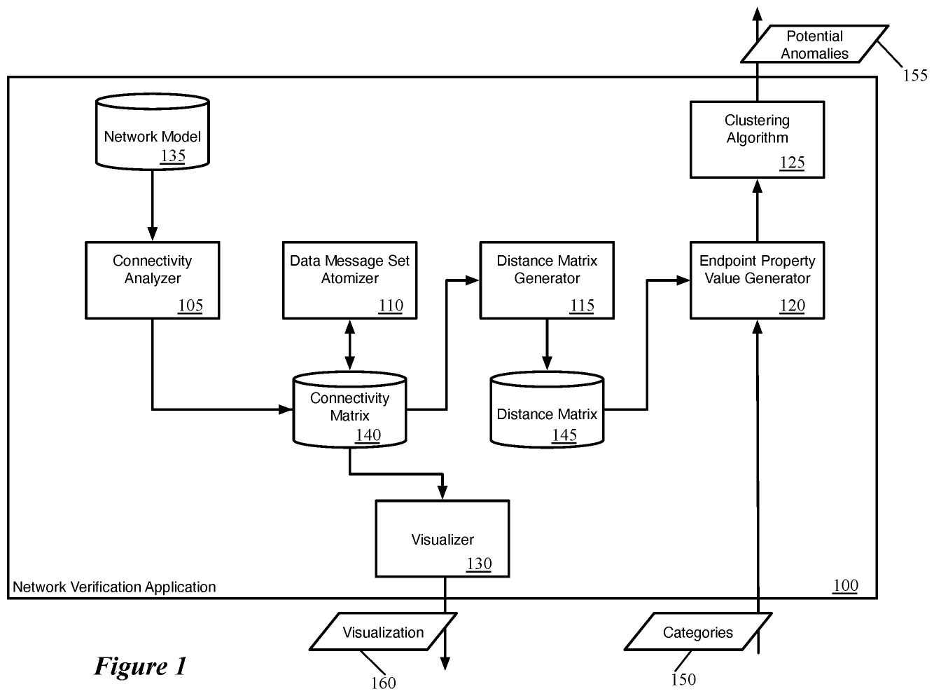

In some embodiments, the method is performed by an application (e.g., a network verification application) that stores and uses a model of the network that includes data message processing rules for each network device in the network (e.g., each physical and logical network device). FIG. 1 conceptually illustrates the architecture of a network verification application 100 of some embodiments. The network verification application 100 includes a connectivity analyzer 105, a data message set atomizer 110, a distance matrix generator 115, an endpoint property value generator 120, a clustering algorithm 125, and a visualizer 130. It should be understood that the illustrated modules are not necessarily a complete representation of the entire functionality of the network verification application of some embodiments, but rather that the figure just shows modules related to network connectivity analysis and anomaly detection.

As shown, the connectivity analyzer 105 receives data from a network model 135. The network model 135, in some embodiments, stores data message processing rules for each network device in the network that is monitored/verified by the application 100. In some embodiments, the network devices represented in the network model 135 include physical devices (e.g., physical switches and routers, middlebox appliances, etc.) and virtual software devices (e.g., virtual switches, virtual routers, software middleboxes, etc.) as well as logical devices (e.g., logical switches and logical routers, distributed middleboxes, etc.). The data message processing rules include forwarding rules, security rules, (e.g., firewall rules), etc., that define how data messages sent to and from network endpoints are processed in the network. In some embodiments, the network model 135 represents these network devices as collections of tables that specify how each device would handle any data message.

The network verification application can simulate the processing of any theoretical data message (or set of data messages) that could occur in the network using the network model 135. For the purposes of connectivity analysis, the network model 135 can be used to determine, for any two network endpoints, the set of data messages that can reach one endpoint when sent from the other. In common usage, the network verification application can verify that specific conditions are met in the network and provide responses to on-demand queries.

The connectivity analyzer 105 uses the network model 135 to generate connectivity data for a set of network endpoints in the network analyzed by the network verification application 100. The network endpoints may include virtual machines (VMs), physical computers, containers, and/or other data compute nodes (DCNs) that communicate via the network. The connectivity analyzer 105 determines, for each network endpoint, the connectivity to each other network endpoint. In some embodiments, for each particular network endpoint, the connectivity analyzer 105 uses the network model 135 to determine a respective set of data messages that would reach each respective other network endpoint when sent from the particular network endpoint.

Specifically, for each network endpoint, the connectivity analyzer 105 of some embodiments performs a free traversal of the network model 135 using a data message set that represents a union of all possible destination addresses. The result of this traversal is a connectivity matrix 140 that specifies the set of data messages that will reach each network endpoint when sent from each other network endpoint. It should be noted that while this network connectivity will often be symmetrical (i.e., any type of data message that reaches VM2 when sent from VM1 will also reach VM1 when sent from VM2), this may not always be the case (due to either anomalies or intentionally asymmetric rules that allow, e.g., connections to be initiated in one direction but not the other).

The data message set atomizer 110 determines a group of atomic data message sets that can be combined together to generate any of the respective data message sets that are reachable at any of the network endpoints from any other network endpoint (i.e., to generate any of the entries in the connectivity matrix 140). The atomic data message sets are defined so that each entry in the connectivity matrix 140 is a combination of one or more of the atomic data message sets. Some embodiments use as few atomic data message sets as possible. For instance, the atomic data message sets could be determined by layer 4 protocol (e.g., TCP data messages, UDP data messages, data messages other than TCP or UDP are possible data message sets), different VLANs, or other protocol headers.

The data message set atomizer 110 uses these atomic data message sets to represent each entry in the connectivity matrix 140 as a vector of Boolean values. Each such vector, for a source and destination network endpoint, specifies which of the atomic data sets is reachable at the destination network endpoint when sent from a source network endpoint. For instance, in the above-mentioned example of TCP, UDP, and non-TCP/UDP data messages, each data message set is represented as a vector of three Boolean values. If only TCP data messages reach the destination network endpoint, this is represented as (1, 0, 0). If all data messages reach the destination network endpoint, this is represented as (1, 1, 1). If all except UDP data messages reach the destination network endpoint, this is represented as (1, 0, 1), and so on.

The distance matrix generator 115 uses the vectorized connectivity matrix 140 to quantify the difference in connectivity between pairs of network endpoints. This difference is not a measure of how reachable or connected one network endpoint is from another network endpoint (that is measured by the connectivity matrix), but rather how different the overall network connectivity is for one network endpoint compared to another network endpoint. That is, if the connectivity of a first network endpoint to each other network endpoint is the same as the connectivity of a second network endpoint to each other network endpoint (with the same connectivity to each other), then there is no connectivity difference between the two network endpoints. The output of the distance matrix generator 115 is a distance matrix 145 that has a single difference value for each pair of network endpoints.

To generate the distance matrix 145 in some embodiments, the distance matrix generator 115 calculates a root mean square value between the vectors for each pair of network endpoints. That is, the larger the number of values that are different between the two vectors for a pair of network endpoints (indicating types of data messages that will reach a particular destination when sent from one of the network endpoints in the pair but not the other), the larger the quantified difference between the pair of network endpoints will be.

Finally, the application 100 uses these quantified differences in the distance matrix 145 to identify clusters of network endpoints and anomalous network endpoints that do not fit the clusters (the latter being indicative of possible anomalies in the network configuration). To perform the clustering, the endpoint property value generator 120 reduces the number of properties based on which to cluster the network endpoints. Using the distance to every other network endpoint as a separate property (i.e., a separate dimension in the space in which clusters are sought) would not scale well to large networks in which each network endpoint could have thousands, if not millions, of individual properties.

Instead, the endpoint property value generator 120 receives a set of categories 150 (e.g., defined by a network administrator or other user of the network verification application 100) as well as values for each network endpoint in those categories and uses these categories to define a set of properties to be used for clustering. In some embodiments, the categories are chosen based on an expectation as to which network endpoints should have similar connectivity. Thus, for example, categories such as the logical switch to which a network endpoint connects or the application and/or application tier to which a network endpoint belongs may be chosen as properties. For each category, the endpoint property value generator 120 computes, for each network endpoint, (i) the average quantified difference between the network endpoint and each other network endpoint having the same value for the category and (ii) the average quantified difference between the network endpoint and each other network endpoint having a different value for the category (e.g., an intra-category average and an extra-category average). That is, for each category, the endpoint property value generator 120 generates three properties: the category itself as well as two numerical properties. Some embodiments then perform clustering based on these properties.

To use the properties for clustering, the clustering algorithm 125 of some embodiments requires a definition of distance between categorical values (e.g., between a value of “logical switch 1” and “logical switch 2”) as well as a normalization of the categorical values to the numerical values. For the first, in some embodiments the clustering algorithm 125 defines the distance between two categorical values to be either 1 (if the values are different) or 0 (if the values are the same). Some embodiments perform a scaling (e.g., using Min Max scaling) of each of the numerical properties so that the values are all between 0 and 1, then compute the distances between the normalized values (e.g., using cosine similarity). The categorical distances are also scaled during clustering (relative to the numerical distances) using a tunable weight parameter in some embodiments.

The points representing network endpoints are input into a clustering algorithm 125 (e.g., a density-based clustering algorithm such as DBSCAN or OPTICS), with distances between the network endpoints defined as noted above. The output of this clustering algorithm 125 is a set of clusters (i.e., network endpoints having the same or extremely similar connectivity) as well as a set of anomalies that do not fit into the clusters. Because misconfiguration may result in a very small change in overall connectivity, in some embodiments the network verification application 100 (either the clustering algorithm 125 or a separate module of the application 100) runs a second pass to identify any network endpoints that have distances varying at all from the other members of their cluster and classifies these network endpoints as potential anomalies as well. These potential anomalies 155 are output to a user (e.g., a network and/or security administrator) for analysis.

In addition to the computational analysis performed by the network verification application 100, in some embodiments the visualizer 130 outputs a reachability (connectivity) visualization 160 based on the connectivity matrix 140, which can allow a user (e.g., a network administrator) that is familiar with the network to quickly identify potential anomalies. In some embodiments, the reachability visualization is displayed as a matrix with each row representing a network endpoint (or group of endpoints) and each column similarly representing a network endpoint or group. Each cell in the matrix indicates whether the destination endpoint (i.e., the column endpoint) is reachable from the source endpoint (i.e., the row endpoint). In some embodiments, each of the cells is colored or otherwise visualized in such a way as to represent the set of data messages that are reachable at the destination endpoint from the source endpoint.

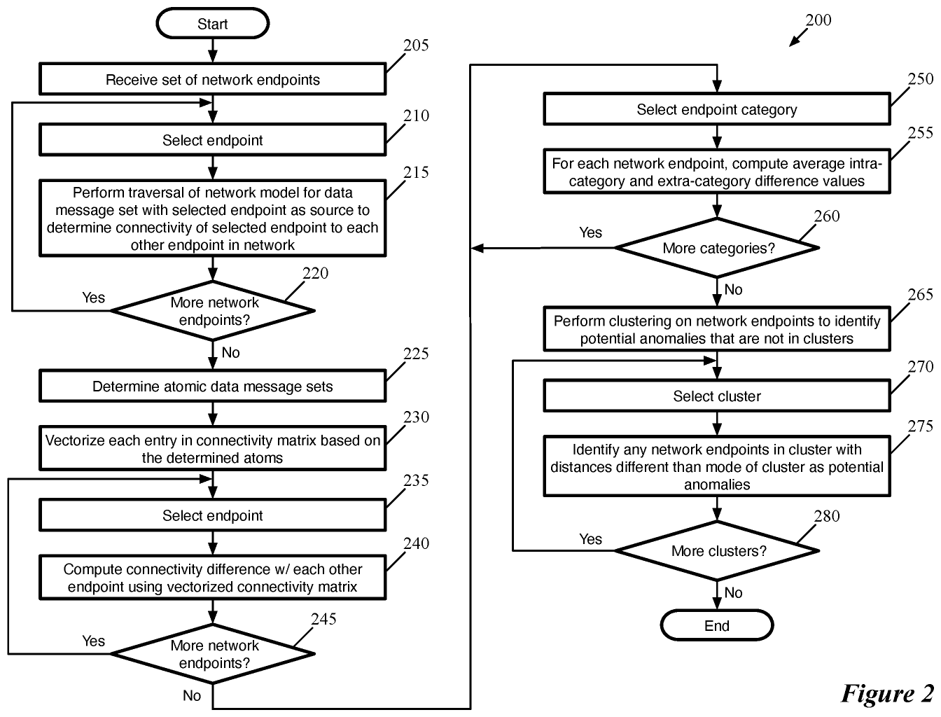

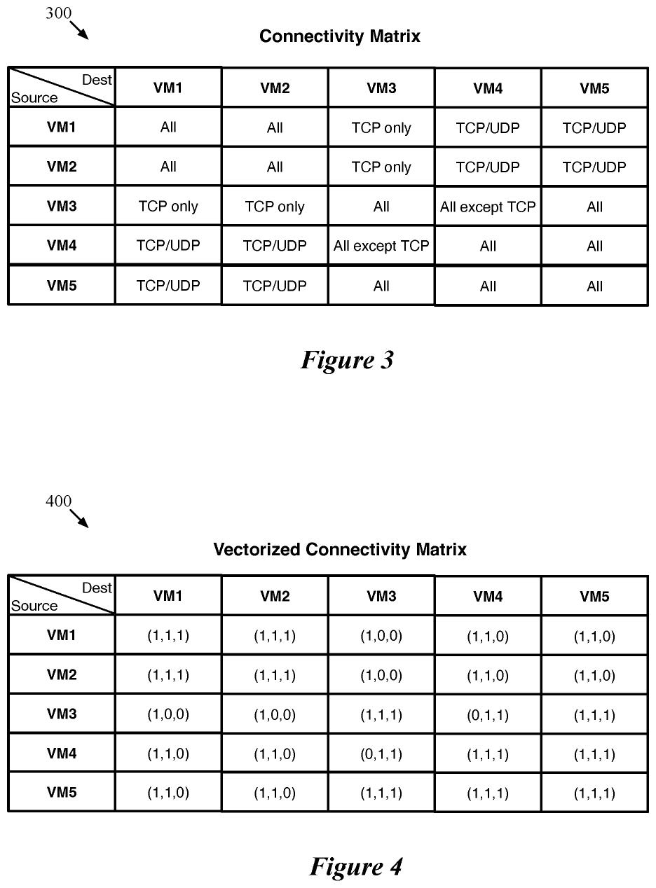

FIG. 2 conceptually illustrates a process 200 of some embodiments for identifying potential anomalies in a network based on connectivity analysis. In some embodiments, the process 200 of some embodiments is performed at least in part by a network verification application (or similar network analysis application) such as that shown in FIG. 1. The process 200 will be described in part by reference to FIGS. 3-6, which show examples of a connectivity matrix, a connectivity difference matrix based on that connectivity matrix, and property difference values used for clustering analysis generated from the connectivity difference matrix.

As shown, the process 200 begins by receiving (at 205) a set of network endpoints for which to perform the connectivity and anomaly analysis. In some embodiments, the network verification/analysis application performs its connectivity and anomaly analysis on a regular basis (e.g., once an hour, once or twice a day, etc.), while in other embodiments the application only performs this analysis upon request from a user (e.g., a network and/or security administrator). The set of network endpoints that are analyzed may include all of the endpoints in a network or a subset of these endpoints specified by the user. As noted, the network endpoints may include physical computers, VMs, containers, or other DCNs that send data traffic in the network.

The process 200 then selects (at 210) a network endpoint and performs (at 215) a traversal of the network model for a data message set with the selected endpoint as the source in order to determine connectivity of the selected endpoint to each other endpoint in the network. As discussed above, the network model of some embodiments stores data message processing rules for each network device in the network that is analyzed by the network verification application. In some embodiments, the network devices represented in the network model include physical devices (e.g., physical switches and routers, middlebox appliances, etc.) and virtual software devices (e.g., virtual switches, virtual routers, software middleboxes, etc.) as well as logical devices (e.g., logical switches and logical routers, distributed middleboxes, etc.). The data message processing rules include forwarding rules, security rules, (e.g., firewall rules), etc., that define how data messages sent to and from network endpoints are processed in the network. In some embodiments, the network model represents these network devices as collections of tables that specify how each device would handle any data message.

To perform the connectivity analysis for a selected endpoint, some embodiments construct a data message set that represents the union of all possible destination addresses (with a source address of the selected endpoint). The application then performs a symbolic traversal with this data message set from the selected endpoint. The data message set may be divided and combined during the traversal, as paths diverge or merge together. As only end-to-end reachability is of use for the anomaly analysis, the traversal does not focus on exploring all possible paths. Instead, once a subset of data messages is determined to either reach an endpoint, blocked, or dropped, that subset of data messages is removed from the symbolic traversal. In some embodiments, the traversal is bidirectional and takes into account stateful correlations between request and reply traffic wherever applicable.

The process 200 then determines (at 220) whether any additional network endpoints remain for analysis. If additional network endpoints remain, the process returns to 210 to select the next network endpoint and perform the necessary data message traversal with the network model. It should be understood that the process 200 is a conceptual process and that some embodiments do not perform the analysis serially for each individual network endpoint. For instance, some embodiments perform the analysis for multiple network endpoints in parallel. In some embodiments, the traversal of the network model is performed with a data message set that begins, collectively, from each possible network endpoint, such that the connectivity analysis is performed for all of the network endpoints at the same time.

Irrespective of how the network model traversal is performed, the result of the connectivity analysis is a matrix that specifies the data message set that reaches each network endpoint from each other network endpoint. FIG. 3 conceptually illustrates an example connectivity matrix 300 for a set of five network endpoints (VM1-VM5). As shown, this connectivity matrix 300 specifies, for each source network endpoint (i.e., each row), the set of data messages that will reach each destination endpoint (i.e., each column). For instance, for VM1, all data messages will reach VM1 (this is the case for any VM) and VM2, but only TCP data messages will reach VM3 while only TCP or UDP data messages will reach VM4 and VM5. In this case, the connectivity matrix is symmetrical (i.e., the set of data messages that will reach any first network endpoint when sent from any second network endpoint is the same as the set of data messages that will reach the second network endpoint when sent from the first network endpoint). However, in some cases the connectivity matrix will be asymmetrical, either owing to a misconfiguration or specific rules regarding which network endpoints can initiate connections with other network endpoints. It should be noted that some embodiments discard any information below layer 4 (i.e., layer 2/3 source and destination addresses) from these data message set definitions, since these header fields will naturally be different for every source-destination pair. Though not shown in the process 200, the connectivity matrix can be used to create visualizations that may be useful for a network administrator. Such visualizations will be described further below.

Returning to FIG. 2, the process 200 determines (at 225) atomic data message sets in order to atomize the connectivity matrix. Specifically, some embodiments determine a group of atomic data message sets that can be combined together to generate any of the respective data message sets that are reachable at any of the network endpoints from any other network endpoint (i.e., to generate any of the entries in the connectivity matrix). Some embodiments use as few atomic data message sets as possible. For instance, the atomic data message sets could be determined by layer 4 protocol (e.g., TCP data messages, UDP data messages, data messages other than TCP or UDP are possible data message sets), different VLANs, or other protocol headers.

Next, the process 200 vectorizes (at 230) each entry in the connectivity matrix based on the determined data message atoms. Each such vector, for a source and destination network endpoint, specifies which of the atomic data sets is reachable at the destination network endpoint when sent from the source network endpoint. FIG. 4 conceptually illustrates the vectorized connectivity matrix 400, based on the connectivity matrix 300 of FIG. 3. In this example, the atomic data message sets are {TCP data messages, UDP data messages, non-TCP/UDP data messages}. As such, each entry in the vectorized connectivity matrix 400 is a three-tuple indicating whether each of these atomic data message sets reaches the destination endpoint when sent from the source endpoint. For instance, only TCP data messages sent from VM1 can reach VM3 (and vice versa), so these entries in the matrix are each vectorized as (1,0,0). On the other hand, all data messages except TCP data messages will reach VM3 when sent from VM4 (and vice versa), so these entries are vectorized as (0,1,1). All of the entries in the connectivity matrix are vectorized based on these data message atoms so that the differences between the connectivity of the different network endpoints can be determined.

The process 200 then uses this vectorized connectivity matrix to determine the differences in connectivity between the network endpoints. As described above, these differences are not measures of how reachable or connected one network endpoint is from another network endpoint (that is measured by the connectivity matrix), but rather how different the overall network connectivity is for one network endpoint compared to another network endpoint. That is, if the connectivity of a first network endpoint to each other network endpoint is the same as the connectivity of a second network endpoint to each other network endpoint (with the same connectivity to each other), then there is no connectivity difference between the two network endpoints.

As shown, the process 200 selects (at 235) one of the network endpoints and computes (at 240) the connectivity difference with each other network endpoint using the vectorized connectivity matrix. Some embodiments compute this difference, for a given pair of network endpoints, as the root mean square value between the connectivity vectors for each of the two network endpoints. The length of these connectivity vectors is the number of atomic data message sets (i.e., three in the illustrated example of FIG. 4) multiplied by the number of network endpoints (i.e., five in the illustrated example).

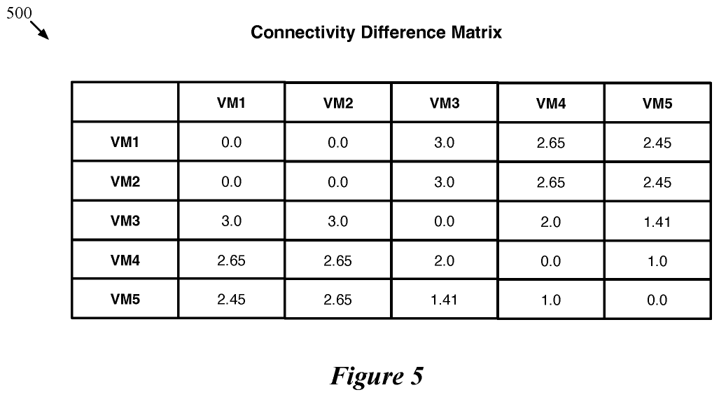

FIG. 5 conceptually illustrates a connectivity difference matrix 500 generated based on the vectorized connectivity matrix 400 shown in FIG. 4. The connectivity difference matrix 500 will be symmetrical even if the connectivity matrix is not, because the calculations are symmetrical (i.e., the difference between endpoint 1 and endpoint 2 is definitionally the same as the difference between endpoint 2 and endpoint 1). In this example, the value in any entry of the connectivity matrix is the square root of the number of differences between the vectors for the two network endpoints represented by that entry. These vectors each have 15 elements; for instance, the vectorized connectivity for VM1 is (1,1,1,1,1,1,1,0,0,1,1,0,1,1,0). VM2 has the exact same vectorized connectivity, so the difference value for these two endpoints is 0.0. The vectors for VM1 and VM4 have seven differences, so the difference value for these two endpoints is 2.65. Each of the entries in the connectivity difference matrix is computed in this way.

It should be noted that some embodiments use a simpler computation for the connectivity difference matrix that does not require atomization of the data message sets. for a pair of network endpoints, this simpler computation method assigns, for each pair of corresponding entries in the original connectivity matrix (i.e., that shown in FIG. 3), a difference of 0 if the entries are the same and a difference of 1 if the entries are at all different. Using this method, for instance, VM1 would have a difference of 5 with each of VM3, VM4, and VM5. However, this simpler method does not quantify how different each pair of connectivity entries is, and so the scheme that uses vectorization based on atomic data message sets may be used instead.

Returning to FIG. 2, the process 200 determines (at 245) whether additional network endpoints remain. When additional network endpoints remain, the process 200 returns to 235 to select the next network endpoint and compute the connectivity difference between that network endpoint and the other network endpoints. It should be understood that, in some embodiments, these calculations are performed for some or all of the network endpoints in parallel. In addition, even if computed serially (as shown in the figure), it should be understood that some embodiments do not perform each difference calculation twice. Rather, for each selected network endpoint, only the difference calculations compared to endpoints that have not yet been selected are computed, because the other difference calculations will have already been computed when the other network endpoint in the pair was selected.

Once the connectivity difference matrix is calculated, the process 200 begins the clustering operations. The connectivity difference matrix specifies how different a given endpoint is from any other endpoint in the network, while to detect anomalous endpoints the application clusters similar endpoints based on the connectivity difference matrix. To perform clustering generally, each item should be assigned a set of properties in some embodiments. While one option is to treat the difference between a given network endpoint and each other network endpoint (i.e., a single row in the matrix) as a list of properties, and perform clustering based upon these values, this approach runs into scaling problems. As the number of network endpoints (e.g., up to the tens or hundreds of thousands), the number of properties for each data point grows similarly, which can add a lot of noise to the clustering algorithm.

As such, some embodiments perform an aggregation of the connectivity difference matrix based on a set of categories. These categories may be defined by a network administrator or other user of the network verification application, and in some embodiments are chosen based on an expectation as to which network endpoints should have similar connectivity (i.e., endpoints with the same value for a given category can be expected to behave similarly). Examples of such categories include the logical switch to which a network endpoint connects as well as the application (and/or specific application tier) to which a network endpoint belongs.

The process 200, as shown, selects (at 250) one of the specified network endpoint categories and, for each network endpoint, computes (at 255) the average intra-category difference value and the average extra-category difference value. For a given category and network endpoint, the intra-category difference value is the average of the difference values between that network endpoint and each other network endpoint (not including that network endpoint) that has the same category value (e.g., connects to the same logical switch). The extra-category difference value, then, is the average of the difference values between that network endpoint and each other network endpoint that has a different category value (e.g., connects to the any other logical switch). Thus, for each category, the application generates three different property values for each network endpoint: (i) the actual value for the category (i.e., the logical switch and or application and tier), (ii) the intra-category average difference, and (iii) the extra-category average difference.

The process 200 then determines (at 260) whether additional categories remain. When more categories remain for which the extra-category and intra-category difference need to be computed, the process returns to 250 to select the next category and compute these averages for each of the network endpoints. As noted previously, it should be understood that the process 200 is a conceptual process and that the application may not select and compute the averages for each category sequentially. Some embodiments nest a loop over the categories within a loop over each network endpoint, while other embodiments perform many or all of the computations in parallel.

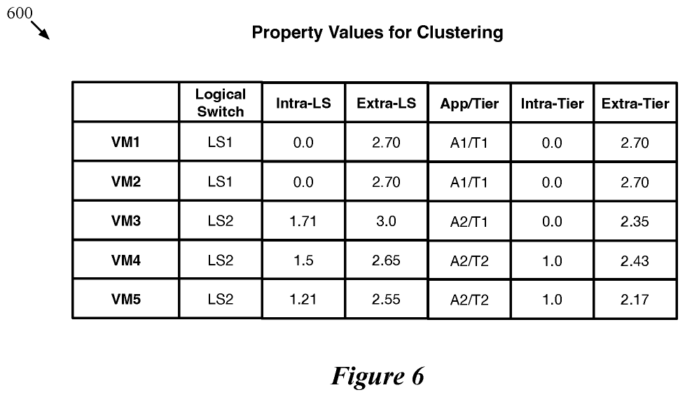

FIG. 6 conceptually illustrates a table 600 with property values computed for two categories based on the connectivity difference matrix 500. As shown, the two categories are logical switch (VM1 and VM2 connect to a first logical switch LS1 while VM3, VM4, and VM5 all connect to a second logical switch LS2) and application tier (VM1 and VM2 both belong to tier T1 of application A1, VM3 belongs to tier T1 of application A2, and VM4 and VM5 both belong to tier T2 of application A2). As such, the table 600 includes six properties: (i) logical switch, (ii) intra-logical switch average, (iii) extra-logical switch average, (iv) application tier, (v) intra-tier average, and (vi) extra-tier average. For example, for VM1, the intra-logical switch and intra-tier averages are 0.0 because there is a 0.0 difference between VM1 and VM2. For VM3, the intra-logical switch average is 1.71 (the average of its differences with VM4 and VM5), the extra-logical switch average is 3.0 (the average of its differences with VM4 and VM5), the intra-tier average is 0.0 (because there are no other members of the same application tier) and the extra-tier average is 2.35 (the average of differences with VM1, VM2, VM4, and VM5).

Once these properties are calculated, the process 200 performs (at 265) clustering on the network endpoints to identify potential anomalies (endpoints that are not in any of the identified clusters). The network endpoints, with the complete set of properties, can be used as inputs into a standard clustering algorithm in some embodiments. Clustering, in some embodiments, effectively plots all of the input points on a set of multi-dimensional axes and identifies clusters of densely packed points according to various specified criteria. In the example shown in the figures, each of the six properties is a separate axis on which the points are plotted. Some embodiments use density-based clustering algorithms such as DBSCAN or OPTICS, which require certain criteria (e.g., the minimum number of points in a cluster, the minimum density of a cluster, etc.).

The properties, however, have mixed-type data, for which certain issues need to be resolved in order to perform clustering. First, distances between categorical (i.e., non-numerical) values need to be defined. Secondly, the scales of categorical distances and numerical distances should be normalized. The first issue relates to the categorical properties (e.g., the “logical switch” or “application tier” properties), which are not numbers and therefore do not have any specific ordering or defined way to calculate distances. For instance, if there are three different logical switches LS1-3, LS2 is not necessarily any closer to LS3 than LS1 is to LS3. As such, some embodiments use a Boolean distance value of 0 if the values are the same (e.g., the distance along the logical switch axis between VM3 and VM4 is 0) and 1 if the values are different (e.g., the distance along the logical switch axis between VM1 and VM4 is 1).

For the second issue, some embodiments first scale the distances between the numerical data. These distances can be large in many cases. For example, in FIG. 6, the distances between values can be as large as 1.71 (e.g., between VM1 and VM3 values for intra-logical switch differences. On the other hand, all of the extra-tier values are packed between 2.17 and 2.70. Accordingly, some embodiments use Min Max scaling to normalize all of the values to be between 0 and 1. Min Max scaling, for each value of a given property, subtracts the minimum value of the property (e.g., 2.17 for the extra-tier property) and then divides this result by the maximum difference within the property (e.g., 2.70−2.17=0.53 for the extra-tier property). Thus, the smallest value for a given property will be set to 0 and the largest value for the property will be set to 1, with the other values scaled in-between. To measure the total distance between the numerical properties of any two points, some embodiments use the cosine similarity (which is defined as the dot product of the vectors divided by the product of their lengths). Finally, some embodiments use another tunable parameter (w) to scale the distances between the categorical (non-numerical) data (i.e., so that these distances are equal to 0 and w rather than 0 and 1). In this case, the final distance between any two points (representing two network endpoints) is

d=w*d_{c}+dₙ,

where d_{c} is the distance between categorical properties and dₙ is the distance between numerical properties.

The output of the clustering algorithm is a set of clusters (of network endpoints with similar connectivity) and a set of data points that do not fit into any of the clusters and are therefore identified as potential anomalies (because they have connectivity differences unlike any of the groups of network endpoints. However, the variance in the distances between the network endpoints may be extremely small, such that some of the anomalies will be included in the clusters and not detected by a first pass.

As such, the process 200 performs additional processing on each of the clusters. As shown, the process 200 selects (at 270) one of the clusters and identifies (at 275) any network endpoints in the cluster with distances that are different from the modal distance within the cluster as also being potential anomalies. These anomalies are often due to small and therefore easily missed misconfigurations. For instance, if a single port on a single protocol is configured anomalously for a network endpoint but the behavior is identical with respect to all other ports and protocols, the distances to other network endpoints in its cluster would be extremely small. This second pass enables these minor but potentially important misconfigurations to be caught.

The process 200 determines (at 280) whether any additional clusters remain for this second-pass analysis. If additional clusters remain, the process returns to 270 to select the next cluster and perform a similar analysis. It should be understood that in different embodiments the application may perform this second-pass analysis in parallel on some or all of the clusters rather than serially as shown in the figure. Once all of the clusters have been analyzed, the process 200 ends, with all of the potential anomalies being identified. A network administrator can then analyze these anomalies to determine whether any of the data message processing rules have been misconfigured, and correct the misconfigurations as needed.

As noted above, some embodiments also generate a visualization of the connectivity matrix, which can be useful to a network administrator that knows what to look for. Some embodiments color (or otherwise distinguish) each cell in the matrix according to the set of data messages that can reach the destination from the source. The visualization engine of some embodiments leverages grouping and labeling either from user input or infers groupings based on endpoint properties (e.g., subnet, reachability frequency, logical switch, etc.). These groupings can be used to determine how to sort the columns and rows for optimal visualization. In some embodiments, the user can limit the visualization to reachability for a specific transport protocol. For example, if TCP is chosen, then the cells are only colored or otherwise highlighted based on TCP traffic connectivity. This visualization allows the user (e.g., administrator) to view a high-level overview of which endpoints have reachability to each other while ignoring certain classes of information, focusing only on those that are of interest.

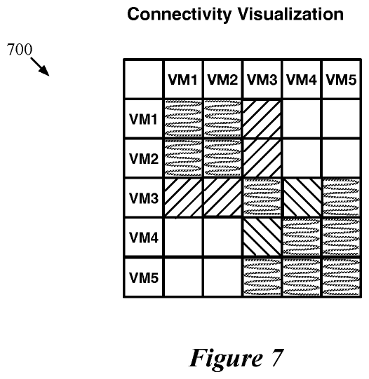

FIG. 7 illustrates an example connectivity visualization 700 based on the connectivity matrix 300 of FIG. 3. In this case, four different visualizations are used for the cells: squiggly lines to indicate reachability for all traffic, one type of diagonal slashes to indicate traffic only for TCP traffic and another type of diagonal slashes to indicate reachability for all traffic except for TCP traffic, and finally no coloration to indicate reachability for TCP and UDP traffic (but not other types of traffic).

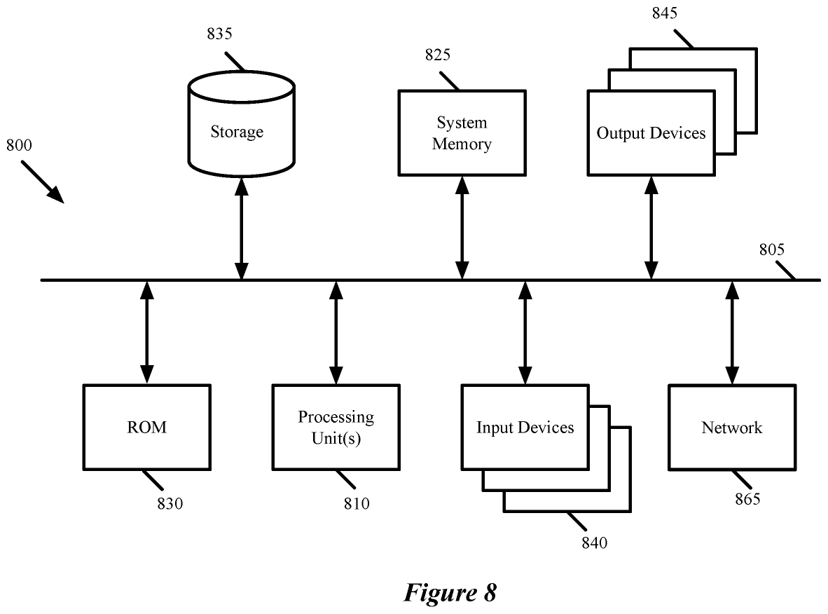

FIG. 8 conceptually illustrates an electronic system 800 with which some embodiments of the invention are implemented. The electronic system 800 may be a computer (e.g., a desktop computer, personal computer, tablet computer, server computer, mainframe, a blade computer etc.), phone, PDA, or any other sort of electronic device. Such an electronic system includes various types of computer readable media and interfaces for various other types of computer readable media. Electronic system 800 includes a bus 805, processing unit(s) 810, a system memory 825, a read-only memory 830, a permanent storage device 835, input devices 840, and output devices 845.

The bus 805 collectively represents all system, peripheral, and chipset buses that communicatively connect the numerous internal devices of the electronic system 800. For instance, the bus 805 communicatively connects the processing unit(s) 810 with the read-only memory 830, the system memory 825, and the permanent storage device 835.

From these various memory units, the processing unit(s) 810 retrieve instructions to execute and data to process in order to execute the processes of the invention. The processing unit(s) may be a single processor or a multi-core processor in different embodiments.

The read-only-memory (ROM) 830 stores static data and instructions that are needed by the processing unit(s) 810 and other modules of the electronic system. The permanent storage device 835, on the other hand, is a read-and-write memory device. This device is a non-volatile memory unit that stores instructions and data even when the electronic system 800 is off. Some embodiments of the invention use a mass-storage device (such as a magnetic or optical disk and its corresponding disk drive) as the permanent storage device 835.

Other embodiments use a removable storage device (such as a floppy disk, flash drive, etc.) as the permanent storage device. Like the permanent storage device 835, the system memory 825 is a read-and-write memory device. However, unlike storage device 835, the system memory is a volatile read-and-write memory, such a random-access memory. The system memory stores some of the instructions and data that the processor needs at runtime. In some embodiments, the invention's processes are stored in the system memory 825, the permanent storage device 835, and/or the read-only memory 830. From these various memory units, the processing unit(s) 810 retrieve instructions to execute and data to process in order to execute the processes of some embodiments.

The bus 805 also connects to the input and output devices 840 and 845. The input devices enable the user to communicate information and select commands to the electronic system. The input devices 840 include alphanumeric keyboards and pointing devices (also called “cursor control devices”). The output devices 845 display images generated by the electronic system. The output devices include printers and display devices, such as cathode ray tubes (CRT) or liquid crystal displays (LCD). Some embodiments include devices such as a touchscreen that function as both input and output devices.

Finally, as shown in FIG. 8, bus 805 also couples electronic system 800 to a network 865 through a network adapter (not shown). In this manner, the computer can be a part of a network of computers (such as a local area network (“LAN”), a wide area network (“WAN”), or an Intranet, or a network of networks, such as the Internet. Any or all components of electronic system 800 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral signals.

This specification refers throughout to computational and network environments that include virtual machines (VMs). However, virtual machines are merely one example of data compute nodes (DCNs) or data compute end nodes, also referred to as addressable nodes. DCNs may include non-virtualized physical hosts, virtual machines, containers that run on top of a host operating system without the need for a hypervisor or separate operating system, and hypervisor kernel network interface modules.

VMs, in some embodiments, operate with their own guest operating systems on a host using resources of the host virtualized by virtualization software (e.g., a hypervisor, virtual machine monitor, etc.). The tenant (i.e., the owner of the VM) can choose which applications to operate on top of the guest operating system. Some containers, on the other hand, are constructs that run on top of a host operating system without the need for a hypervisor or separate guest operating system. In some embodiments, the host operating system uses name spaces to isolate the containers from each other and therefore provides operating-system level segregation of the different groups of applications that operate within different containers. This segregation is akin to the VM segregation that is offered in hypervisor-virtualized environments that virtualize system hardware, and thus can be viewed as a form of virtualization that isolates different groups of applications that operate in different containers. Such containers are more lightweight than VMs.

Hypervisor kernel network interface modules, in some embodiments, is a non-VM DCN that includes a network stack with a hypervisor kernel network interface and receive/transmit threads. One example of a hypervisor kernel network interface module is the vmknic module that is part of the ESXi™ hypervisor of VMware, Inc.

It should be understood that while the specification refers to VMs, the examples given could be any type of DCNs, including physical hosts, VMs, non-VM containers, and hypervisor kernel network interface modules. In fact, the example networks could include combinations of different types of DCNs in some embodiments.

While the invention has been described with reference to numerous specific details, one of ordinary skill in the art will recognize that the invention can be embodied in other specific forms without departing from the spirit of the invention. In addition, a number of the figures (including FIG. 2) conceptually illustrate processes. The specific operations of these processes may not be performed in the exact order shown and described. The specific operations may not be performed in one continuous series of operations, and different specific operations may be performed in different embodiments. Furthermore, the process could be implemented using several sub-processes, or as part of a larger macro process. Thus, one of ordinary skill in the art would understand that the invention is not to be limited by the foregoing illustrative details, but rather is to be defined by the appended claims.

1. A method for identifying anomalies in a network, the method comprising:
using a model of the network to determine connectivity for each of a plurality of network endpoints to other network endpoints in the plurality of network endpoints;
quantifying differences in the determined connectivity for pairs of the network endpoints; and
using the quantified differences to identify (i) clusters of network endpoints with similar properties and connectivity and (ii) anomalous network endpoints that do not fit the clusters, wherein the anomalous endpoints are reported as potential network anomalies.

2. The method of claim 1, wherein the plurality of network endpoints comprises at least one of virtual machines and containers.

3. The method of claim 1, wherein the model of the network stores data message processing rules for each of a plurality of network devices in the network.

4. The method of claim 3, wherein the network devices comprise physical network devices and logical network devices.

5. The method of claim 1, wherein, for each particular network endpoint in the plurality of network endpoints, using the network model to determine connectivity comprises determining a respective set of data messages that reach each respective other network endpoint in the plurality of network endpoints when sent from the particular network endpoint.

6. The method of claim 5, wherein, for each particular network endpoint, determining the respective set of data messages comprises performing a free traversal of the network model using a data message set that represents a union of all possible destination addresses in the network.

7. The method of claim 5, wherein quantifying the differences in the determined connectivity for pairs of the network endpoints comprises:
determining a group of atomic data message sets that can be combined together to generate any of the respective data message sets that reach any of the network endpoints from any other network endpoint;
determining a vector of Boolean values that represents each respective data message set as a combination of the atomic data message sets; and
for each pair of network endpoints, quantifying the difference between the vectors of Boolean values for the pair of network endpoints.

8. The method of claim 7, wherein quantifying the difference between the vectors of Boolean values for a particular pair of network endpoints comprises computing a root mean square value between the vectors for the particular pair of network endpoints.

9. The method of claim 1, wherein using the quantified differences to identify clusters and anomalous network endpoints comprises:
for each network endpoint in the plurality of network endpoints, determining a value for each property of a set of properties, the set of properties comprising (i) a set of categories and (ii) a set of numerical properties, the values for the numerical properties computed based on the categories and the quantified differences; and
using the determined values to identify the clusters of network endpoints.

10. The method of claim 9, wherein, for each network endpoint, determining the value for the set of numerical properties comprises, for each category in the set of categories, computing (i) an average quantified difference in the determined connectivity between the network endpoint and each other network endpoint having a same value as the network endpoint for the category and (ii) an average quantified difference in the determined connectivity between the network endpoint and each other network endpoint having a different value than the network endpoint for the category.

11. The method of claim 9, wherein using the quantified differences to identify clusters and anomalous network endpoints further comprises identifying the clusters based on distances between the values for the properties of the set of properties.

12. The method of claim 1 further comprising generating a visualization of the determined connectivity for each network endpoint of the plurality of network endpoints.

13. A non-transitory machine-readable medium storing a program which when executed by at least one processing unit identifies anomalies in a network, the program comprising sets of instructions for:
using a model of the network to determine connectivity for each of a plurality of network endpoints to other network endpoints in the plurality of network endpoints;
quantifying differences in the determined connectivity for pairs of the network endpoints; and
using the quantified differences to identify (i) clusters of network endpoints with similar properties and connectivity and (ii) anomalous network endpoints that do not fit the clusters, wherein the anomalous endpoints are reported as potential network anomalies.

14. The non-transitory machine-readable medium of claim 13, wherein the model of the network stores data message processing rules for each of a plurality of network devices in the network.

15. The non-transitory machine-readable medium of claim 13, wherein, for each particular network endpoint in the plurality of network endpoints, the set of instructions for using the network model to determine connectivity comprises a set of instructions for determining a respective set of data messages that reach each respective other network endpoint in the plurality of network endpoints when sent from the particular network endpoint.

16. The non-transitory machine-readable medium of claim 15, wherein, for each particular network endpoint, the set of instructions for determining the respective set of data messages comprises a set of instructions for performing a free traversal of the network model using a data message set that represents a union of all possible destination addresses in the network.

17. The non-transitory machine-readable medium of claim 15, wherein the set of instructions for quantifying the differences in the determined connectivity for pairs of the network endpoints comprises sets of instructions for:
determining a group of atomic data message sets that can be combined together to generate any of the respective data message sets that reach any of the network endpoints from any other network endpoint;
determining a vector of Boolean values that represents each respective data message set as a combination of the atomic data message sets; and
for each pair of network endpoints, quantifying the difference between the vectors of Boolean values for the pair of network endpoints.

18. The non-transitory machine-readable medium of claim 13, wherein the set of instructions for using the quantified differences to identify clusters and anomalous network endpoints comprises sets of instructions for:
for each network endpoint in the plurality of network endpoints, determining a value for each property of a set of properties, the set of properties comprising (i) a set of categories and (ii) a set of numerical properties, the values for the numerical properties computed based on the categories and the quantified differences; and
using the determined values to identify the clusters of network endpoints.

19. The non-transitory machine-readable medium of claim 18, wherein, for each network endpoint, the set of instructions for determining the value for the set of numerical properties comprises a set of instructions for computing, for each category in the set of categories, (i) an average quantified difference in the determined connectivity between the network endpoint and each other network endpoint having a same value as the network endpoint for the category and (ii) an average quantified difference in the determined connectivity between the network endpoint and each other network endpoint having a different value than the network endpoint for the category.

20. The non-transitory machine-readable medium of claim 18, wherein the set of instructions for using the quantified differences to identify clusters and anomalous network endpoints further comprises a set of instructions for identifying the clusters based on distances between the values for the properties of the set of properties.

21. The non-transitory machine-readable medium of claim 13, wherein the program further comprises a set of instructions for generating a visualization of the determined connectivity for each network endpoint of the plurality of network endpoints.
